(19) United States
(12) Patent Application Publication
(10) Pub. No.: US 2026/0136410 A1
(43) Pub. Date: May 14, 2026

(54) VEHICLE PAIR SELECTION FOR EFFICIENT V2X WIRELESS COMMUNICATION AT TRAFFIC WAITING ZONES

(71) Applicant: TOYOTA MOTOR ENGINEERING & MANUFACTURING NORTH AMERICA, INC., Plano, TX (US)

(72) Inventors: Chunghan LEE, Mountain View, CA (US); Seyhan UCAR, Mountain View, CA (US); Emrah Akin SISBOT, Mountain View, CA (US); Onur ALTINTAS, Mountain View, CA (US); Kentaro OGUCHI, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-Shi (JP)

(21) Appl. No.: 18/943,746

(22) Filed: Nov. 11, 2024

(51) Int. Cl. H04W 76/14; H04W 4/46; H04W 28/02; H04W 84/18

(52) U.S. Cl. CPC H04W 76/14; H04W 28/0226; H04W 4/46; H04W 84/18

(57) ABSTRACT

Systems and methods are provided for anticipatory vehicle pair selection for more efficient vehicle-to-everything (V2X) wireless communication at traffic waiting zones. An example method may comprise: (1) determining a first vehicle intends to transmit data to another vehicle; (2) while the first vehicle traverses a road segment approaching a traffic waiting zone, selecting, from a group of vehicles traversing the road segment with the first vehicle, a second vehicle to receive the data from the first vehicle when the first and second vehicles are within the traffic waiting zone; and (3) before the first and second vehicles reach the traffic waiting zone, assigning the first and second vehicles as a sender-receiver pair for transmitting the data when the first and second vehicles are within the traffic waiting zone.

### TECHNICAL FIELD

The present disclosure relates generally to automotive systems and technologies. More particularly, some embodiments relate to anticipatory vehicle pair selection for more efficient vehicle-to-everything (V2X) wireless communication at traffic waiting zones.

### DESCRIPTION OF RELATED ART

Vehicle-to-everything (V2X) networks enable vehicles to communicate wirelessly via one or more communication protocols. Examples of V2X networks may include Dedicated Short-Range Communication (DSRC) networks that facilitate Basic Safety Messages (BSMs) and Personal Safety Messages (PSMs), among other types of DSRC communication. Other examples of V2X networks Include Bluetooth® networks; Long-Term Evolution (LTE) networks; millimeter wave (mmWave) networks; 3G networks; 4G networks; 5G networks; Voice over LTE (VoLTE) networks; etc.

V2X networks can include vehicle-to-vehicle (V2V) networks, vehicle-to-infrastructure (V2I) networks, vehicle-to-network (V2N) networks, or any combination thereof.

An example application for V2X networks is a vehicular micro cloud (VMC). A VMC may refer to a group of interconnected vehicles (and in some cases interconnected roadside infrastructure elements) that share resources to complete a task. For example, a group of vehicles traversing a common road segment can collectively form a VMC. Members of the VMC can offer their respective resources (e.g., sensor resources, processing resources, memory resources, communication resources, etc.) to collaboratively perform a task (sometimes referred to herein as a VMC task). Examples of VMC tasks may include sensing tasks, computing tasks, storage tasks, communication tasks, etc. Members of the VMC can share data via different types of V2X networks. Output associated with VMC tasks (e.g., recommendations to make threat-mitigating actions such as changing a lane or altering a speed responsive to a detected threat) may be shared among VMC members. In various implementations, a VMC may comprise a leader that assigns sub-tasks (sometimes referred to herein as VMC sub-tasks) to members and distributes the collective output derived from the sub-tasks to VMC members.

Aside from VMCs, there are various other situations where one vehicle may need/desire to transmit data to another vehicle. For example, vehicles may exchange data relevant to sensed conditions on a roadway, to coordinate cooperative driving maneuvers, to leverage surplus processing or memory storage resources of another vehicle, etc. In these situations, vehicles may also use V2X networks to transfer such data.

### BRIEF SUMMARY OF THE DISCLOSURE

According to various embodiments of the presently disclosed technology, a system is provided. The system may comprise: (1) one or more processors; and (2) memory storing machine-readable instructions that, when executed by the one or more processors, cause the system to: (a) form a vehicular micro cloud (VMC) comprising vehicles that share resources to complete a task, wherein executing the task requires a first vehicle of the VMC to transmit data to another vehicle of the VMC; (b) while the vehicles of the VMC traverse a region of a road segment approaching a traffic waiting zone, select a second vehicle of the VMC to receive the data from the first vehicle when the first and second vehicles are within the traffic waiting zone; and (c) before the first and second vehicles reach the traffic waiting zone, assign the first and second vehicles as a sender-receiver pair for transmitting the data when the first and second vehicles are within the traffic waiting zone.

In some embodiments of the system, the memory may store further machine-readable instructions that, when executed by the one or more processors, cause the system to, before the first and second vehicles reach the traffic waiting zone, cause the first and second vehicles to establish a vehicle-to-everything (V2X) connection for transmitting the data.

In certain embodiments of the system, the traffic waiting zone may comprise a second region of the road segment, bounded at one end by a traffic signal, and extending away from the traffic signal towards the region of the road segment by a determined distance.

In various embodiments the system, the memory may store further machine-readable instructions that, when executed by the one or more processors, cause the system to determine at least one vehicle of the VMC is within a second threshold distance of the traffic waiting zone. Here, selecting the second vehicle of the VMC may be responsive to the determination that at least one vehicle of the VMC is within the second threshold distance of the traffic waiting zone.

In some embodiments of the system, the memory may store further machine-readable instructions that, when executed by the one or more processors, cause the system to: (a) determine at least one vehicle of the VMC is within a second threshold distance of the traffic waiting zone; and (b) predict that the first vehicle will stop within the traffic waiting zone for over a threshold time interval. Here, selecting the second vehicle of the VMC may be responsive to the determination that at least one vehicle of the VMC is within the second threshold distance of the traffic waiting zone and the prediction that the first vehicle will stop within the traffic waiting zone for over the threshold time interval. In certain of these embodiments, the memory may store further machine-readable instructions that, when executed by the one or more processors, cause the system to determine the threshold time interval based on a size of the data to be transferred within the traffic waiting zone. In various embodiments, the traffic signal may comprise a traffic light and predicting that the first vehicle will stop within the traffic waiting zone for over the threshold time interval can be based on known timing of the traffic light.

In certain embodiments of the system, selecting the second vehicle of the VMC may comprise: (a) predicting that among the vehicles of the VMC, the second vehicle will be a shortest distance from the first vehicle when the first vehicle is stopped within the traffic waiting zone; and (b) selecting the second vehicle is based on the prediction that among the vehicles of the VMC, the second vehicle will be a shortest distance from the first vehicle when the first vehicle is stopped within the traffic waiting zone. In some of such embodiments, predicting that among the vehicles of the VMC, the second vehicle will be the shortest distance from the first vehicle when the first vehicle is stopped within the traffic waiting zone can be based on at least one of: (a) contemporaneous distances between the vehicles of the VMC when traversing the road segment; (b) contemporaneous relative positions of the vehicles of the VMC within lanes of the road segment when traversing the road segment; and (c) predicted lane changes by one or more vehicles of the VMC before reaching the traffic waiting zone. Here, the memory may store further machine-readable instructions that, when executed by the one or more processors, cause the system to determine the contemporaneous distances between the vehicles of the VMC based on round-trip time (RTT) for packets exchanged between the vehicles of the VMC when traversing the road segment. Relatedly, the predicted lane changes may be based on at least one of: (i) intent messages shared by the one or more vehicles predicted to change lanes; (ii) navigation data of the one or more vehicles predicted to change lanes; and (iii) contemporaneous orientations and headings of the one more vehicles predicted to change lanes.

In various embodiments of the system, selecting the second vehicle of the VMC may comprise: (a) predicting that one or more vehicles of the VMC, including the second vehicle, will travel in a common direction with the first vehicle after leaving the traffic waiting zone; (b) predicting that among the one or more vehicles of the VMC predicted to travel in the common direction with the first vehicle after leaving the traffic waiting zone, the second vehicle will be a shortest distance from the first vehicle when the first vehicle is stopped within the traffic waiting zone; and (c) selecting the second vehicle based on the predictions. Here, predicting that the one or more vehicles of the VMC, including the second vehicle, will travel in the common direction with the first vehicle after leaving the traffic waiting zone may be based on at least one of: (i) intent messages shared by the one or more vehicles predicted to travel in the common direction with the first vehicle after leaving the traffic waiting zone; (ii) navigation data of the one or more vehicles predicted to travel in the common direction with the first vehicle after leaving the traffic waiting zone; (iii) contemporaneous orientations and headings of the one more vehicles predicted to travel in the common direction with the first vehicle after leaving the traffic waiting zone; and (iv) contemporaneous lane positions of the one more vehicles predicted to travel in the common direction with the first vehicle after leaving the traffic waiting zone.

In some embodiments of the system, the system may be implemented in at least one of the vehicles of the VMC.

In certain embodiments of the system, the system may be implemented as a remote computing system.

In various embodiments of the presently disclosed technology, a method if provided. The method may comprise: (1) determining a first vehicle intends to transmit data to another vehicle; (2) while the first vehicle traverses a road segment approaching a traffic waiting zone, selecting, from a group of vehicles traversing the road segment with the first vehicle, a second vehicle to receive the data from the first vehicle when the first and second vehicles are within the traffic waiting zone; and (3) before the first and second vehicles reach the traffic waiting zone, assigning the first and second vehicles as a sender-receiver pair for transmitting the data when the first and second vehicles are within the traffic waiting zone.

In some embodiments of the method, the method may further comprise: (a) before the first and second vehicles reach the traffic waiting zone, causing the first and second vehicles to establish a vehicle-to-everything (V2X) connection for transmitting the data; and (b) causing the first vehicle to transmit the data to the second vehicle over the V2X connection when the first and second vehicles are within the traffic waiting zone.

In various embodiments of the presently disclosed technology, a first vehicle is provided. The first vehicle may comprise: (1) one or more processors; and (2) memory storing machine-readable instructions that, when executed by the one or more processors, cause the first vehicle to: (a) join a vehicular micro cloud (VMC) comprising vehicles that share resources to complete a task, wherein executing the task requires the first vehicle to transmit data to another vehicle of the VMC; (b) while the vehicles of the VMC traverse a region of a road segment approaching a traffic waiting zone, select a second vehicle of the VMC to receive the data from the first vehicle when the first and second vehicles are within the traffic waiting zone; (c) before the first and second vehicles reach the traffic waiting zone, establish a vehicle-to-everything (V2X) connection between the first and second vehicles; and (d) transmit the data to the second vehicle over the V2X connection when the first and second vehicles are within the traffic waiting zone.

In certain embodiments of the first vehicle, joining the VMC may comprise forming the VMC and becoming leader of the VMC.

In some embodiments of the vehicle, the traffic waiting zone may comprise a second region of the road segment, bounded at one end by a traffic signal, and extending away from the traffic signal towards the region of the road segment by a determined distance.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A-1B illustrate an example road segment over which embodiments of the presently disclosed technology may be implemented.

FIG. 2 illustrates an example vehicle, in accordance with various embodiments of the presently disclosed technology.

FIG. 3 illustrates an example implementation of a vehicle-to-everything (V2X) pairing selection management system, in accordance with various embodiments of the presently disclosed technology.

FIG. 4 illustrates an example process that may be performed by a V2X pairing selection management system, in accordance with various embodiments of the presently disclosed technology.

FIG. 5 illustrates another example process that may be performed by a V2X pairing selection management system, in accordance with various embodiments of the presently disclosed technology.

FIG. 6 illustrates an example process that may be performed by a vehicle to make an anticipatory V2X pairing selection, in accordance with various embodiments of the presently disclosed technology.

FIG. 7 is an example computing component that may be used to implement various features of embodiments described in the present disclosure.

The figures are not exhaustive and do not limit the present disclosure to the precise form disclosed.

### DETAILED DESCRIPTION

As described above, V2X networks enable vehicles to communicate and transmit data wirelessly via one or more communication protocols.

In general, stability for V2X communication decreases (e.g., with longer and more variable packet round-trip times (RTTs), higher incidence of packet loss, etc.) with increasing proximity between a sender vehicle (i.e., a vehicle transmitting data) and a receiver vehicle (i.e., a vehicle receiving data). Physical obstructions between the sender-receiver pair (e.g., intermediate vehicles positioned between the sender-receiver pair, roadside infrastructure positioned between the sender-receiver pair, etc.) and relative movement between the sender-receiver pair (e.g., the sender-receiver pair moving farther apart, or moving with different headings) can also negatively impact stability for V2X communication.

For the reasons above, traffic waiting zones can provide favorable conditions for V2X network stability. As used herein, a traffic waiting zone may refer to a region of a road segment where nominal vehicle speed is stopped or is less than 5 MPH. An example of a traffic waiting zone may be a traffic signal waiting zone. For instance, an example traffic signal waiting zone may comprise a region of a road segment bounded at one end by a traffic signal (e.g., a traffic light, stop sign, yield sign, etc.), and extending away from the traffic signal by a determined distance (e.g., 50 feet). Although embodiments of the technology disclosed and claimed herein may be used in applications with any number of traffic waiting zones (e.g., traffic jams, queuing for road obstacles/impediments, construction zones and so on), this specification often describes embodiments in terms of traffic signal waiting zones. This is done for ease of explanation only and not by way of limitation.

As alluded to above, traffic waiting zones can provide favorable conditions for V2X network performance (e.g., as measured by round trip time (RTT) for exchanges packets). Namely, while waiting (e.g., stopped/stationary) within traffic waiting zones, vehicles are often within close proximity, and not moving relative to each other. Relatedly, it is less likely that a new obstruction will be introduced between a sender-receiver pair during data transmission. The heightened V2X network performance often present at traffic waiting zones can be especially important when a relatively large amount of data needs to be transmitted in a particular order, or via a continuous transmission. Accordingly, a substantial amount of V2X communication may generally occur when vehicles are waiting (e.g., stopped/stationary) within traffic waiting zones.

However, proliferation of V2X communication at traffic waiting zones can present challenges as well. For example, when a large number of vehicles are trying to communicate via V2X networks while waiting at a traffic light, wireless communication channels in that geographic region can become overloaded. With overloaded wireless communication channels, V2X networks may have reduced performance, and data transmission times can increase.

With increasing data transmission times, in some cases a sender vehicle may not be able to complete a data transmission (that the sender vehicle would otherwise be able to complete if not overloaded wireless communication channels) before the sender vehicle moves apart from a receiver vehicle after leaving the traffic waiting zone (e.g., after a traffic light turns from red to green). Such incomplete data transmission can negatively impact performance of VMC tasks and other collaborations between vehicles.

For the reasons stated above, technical solutions that facilitate reduced (or more selective) V2X communication at traffic waiting zones can provide tremendous benefits.

Against this backdrop, systems and methods of the presently disclosed technology can be implemented to reduce V2X communication at traffic waiting zones by making anticipatory vehicle communication pair selections while vehicles are approaching a traffic waiting zone. Namely, the V2X communications typically required to make such vehicle communication pair selections (and in some cases, subsequent assignments) can be made before the vehicles reach the traffic waiting zone—thus reducing the quantity of packets exchanged and V2X communication link setup times within the traffic waiting zone. Relatedly, in certain implementations, systems and methods can cause a selected sender-receiver pair to establish a V2X connection for transmitting data prior to reaching the traffic waiting zone. Accordingly, the selected sender-receiver pair can initiate transmission of the data immediately upon (or in some cases in advance of) entering the traffic waiting zone. In these ways, systems and methods can reduce load on wireless communication channels at the traffic waiting zone and improve efficiency of V2X communication therein.

In some implementations, systems and methods can leverage or support VMCs when making anticipatory vehicle communication pair selections while vehicles are approaching a traffic waiting zone.

For example, a system of the presently disclosed technology (e.g., a cloud-based system or a system implemented across one or more vehicles) can form a VMC comprising vehicles that share resources to complete a task. Here, executing the task may require a first vehicle of the VMC to transmit data to another vehicle of the VMC. As alluded to above, in some cases the data (e.g., a large data file) may need to be transmitted in a particular order, or via a continuous transmission. Accordingly, transmission of the data while the first vehicle is stationary/waiting at a traffic waiting zone—i.e., where a V2X network has highest performance—may be required/favorable.

Accordingly, while the vehicles of the VMC traverse a region of a road segment approaching the traffic waiting zone, the system can anticipatorily select a second vehicle of the VMC to receive the data from the first vehicle when the first and second vehicles are within (e.g., stationary/waiting) the traffic waiting zone. The system can use various techniques to make this selection.

For example, in certain implementations the system can first predict that one or more vehicles of the VMC, including the second vehicle, will travel in a common direction with the first vehicle after leaving traffic waiting zone (e.g., straight through an intersection after leaving a traffic signal waiting zone, make a right turn through an intersection after leaving a traffic signal waiting zone, etc.). This first prediction can be important in situations where data transfer between the first and second vehicles may need to continue after leaving the traffic waiting zone (e.g., at the next traffic signal waiting zone of the road segment). The system can next predict that among the one or more vehicles of the VMC predicted to travel in the common direction with the first vehicle after leaving the traffic waiting zone, the second vehicle will be a shortest distance from the first vehicle when the first vehicle is stopped within the traffic waiting zone. This second prediction can be important for improved V2X communication performance—which generally increases with decreasing proximity between a sender-receiver pair. Accordingly, based on the first and second predictions, the system can select the second vehicle to receive the data from the first vehicle when the first and second vehicles are within the traffic waiting zone.

As alluded to above, the system may rely on V2X communications between vehicles to make the predictions of the previous paragraph. By their nature, such V2X communications may be less sensitive to V2X network performance than transferring the data (e.g., a large data file).

For example, the system can leverage intent messages or navigation data shared amongst vehicles of the VMC to predict that the one or more vehicles of the VMC, including the second vehicle, will travel in the common direction with the first vehicle after leaving the traffic waiting zone.

As another example, the system can measure round-trip time (RTT) for packets exchanged between the vehicles of the VMC when traversing the road segment to estimate contemporaneous distances between the vehicles as they traverse the road segment. The system can use such contemporaneous distances to predict future distances between the vehicles when they reach the traffic waiting zone.

As another example, the system can leverage intent messages or navigation data shared amongst vehicles of the VMC to predict lane changes by one or more vehicles of the VMC before reaching the traffic waiting zone. The system can use such predicted lane changes to more intelligently predict future distances between the vehicles when they reach the traffic waiting zone—along with potential obstructions between a prospective sender-receiver pair.

By performing the above-described V2X communications to make intelligent sender-receiver pair selections before reaching the traffic waiting zone, the system can reduce the quantity of packets exchanged and V2X communication link setup times within the traffic waiting zone. Accordingly, the system can reduce load (e.g., as measured by a number of packets exchanged and V2X communication link setup times) on wireless communication channels at the traffic waiting zone and improve efficiency of V2X communication therein.

After selecting the second vehicle of the VMC to receive the data from the first vehicle when the first and second vehicles are within the traffic waiting zone, the system can assign the first and second vehicles as a sender-receiver pair for transmitting the data when the first and second vehicles are within the traffic waiting zone. Such an assignment may be made via V2X communication with the first and second vehicles before the first and second vehicles reach the traffic waiting zone.

In some implementations, the system can further cause the first and second vehicles to establish a V2X connection for transmitting the data within the traffic waiting zone. Establishing such a connection often involves multiple wireless communications between the vehicles. Accordingly, in certain implementations the system can cause the first and second vehicles to establish the V2X connection before reaching the traffic waiting zone. In this way, V2X communications can be further reduced at the traffic waiting zone, and the first vehicle can start transmitting the data over the established V2X connection immediately upon reaching (or stopping within) the traffic waiting zone.

In various implementations, the system can make the above-described sender-receiver pair selection (i.e., between the first and second vehicles) in response to: (1) detecting at least one vehicle of the VMC is within a threshold distance (e.g., 200 feet) of the traffic waiting zone; and (2) predicting that the first vehicle will stop within the traffic waiting zone for over a threshold time interval (e.g., a time interval sufficient to transmit the data). In this way, the system can reduce the likelihood of making an improper sender-receiver pair selection, or making a sender-receiver pair selection that does not result in transmission of the data. In some implementations, the system can determine the threshold time interval based on a size of the data to be transferred within the traffic waiting zone. Relatedly, where the traffic waiting zone is a traffic signal waiting zone associated with a traffic light, predicting that the first vehicle will stop within the traffic signal waiting zone for over the threshold time interval can be based on known timing of the traffic light.

Systems and methods of the presently disclosed technology will now be described in conjunction with the following FIGs.

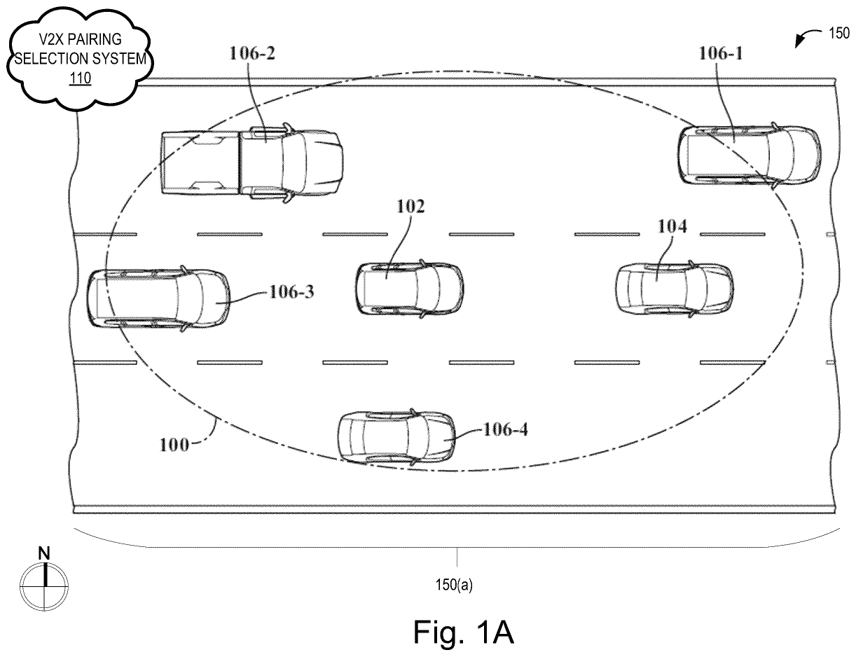

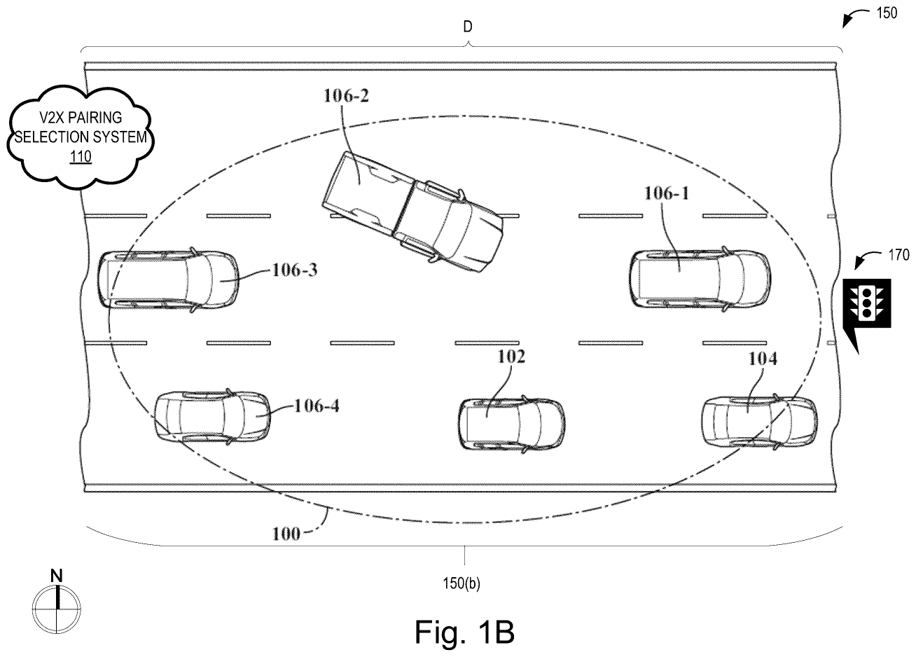

FIGS. 1A and 1B illustrate regions of a road segment 150 over which embodiments of the presently disclosed technology may be implemented.

Namely, FIG. 1A illustrates an example region 150(a) that vehicles traverse when approaching a traffic signal waiting zone 150(b) of road segment 150. FIG. 1B illustrates traffic signal waiting zone 150(b).

Traffic signal waiting zone 150(b) may comprise a region of road segment 150 proximate a traffic signal 170. More particularly, in certain implementations, traffic signal waiting zone 150(b) may comprise a region of road segment 150 bounded by traffic signal 170 on one side (e.g., the east side in FIG. 1B), and extending away (e.g., in the western direction in FIG. 1B) from traffic signal 170 by a determined distance (D). Traffic signal 170 may comprise various types of traffic signals, such as a traffic light or a traffic sign (e.g., a stop sign, a yield sign, etc.). As described above, traffic signal waiting zone 150(b) may be a region of road segment 150 where nominal vehicle speed is stopped or is less than 5 MPH (e.g., while vehicles wait for traffic signal 170 to turn from red to green).

Region 150(a) may be a region of road segment 150 that vehicles traverse when approaching traffic signal waiting zone 150(b). In various implementations, a first boundary of region 150(a) (e.g., the western boundary of region 150(a) in FIG. 1A) may be a first determined distance from the closest boundary of traffic signal waiting zone 150(b) (e.g., the western boundary of traffic signal waiting zone 150(b). Similarly, a second boundary of region 150(a) (e.g., the eastern boundary of region 150(a) in FIG. 1A) may be a second determined distance from the closest boundary of traffic signal waiting zone 150(b) (e.g., the western boundary of traffic signal waiting zone 150(b)).

As depicted in FIG. 1A, a sender vehicle 104 and prospective receiver vehicles 102, 106-1, 106-2, 106-3, and 106-4 may be traversing region 150(a) on their approach to traffic signal waiting zone 150(b). Here, sender vehicle 104 may need to send a large data file (e.g., as part of a VMC task). Prospective receiver vehicles 102, 106-1, 106-2, 106-3, and 106-4 may be prospective/potential receivers of the large data file. As described in greater detail below, in certain implementations sender vehicle 104 and prospective receiver vehicles 102, 106-1, 106-2, 106-3, and 106-4 may form a VMC 100.

As described above, a V2X pairing selection system 110 (e.g., a cloud-based system, a system implemented across one or more of sender vehicle 104 and prospective receiver vehicles 102, 106-1, 106-2, 106-3, and 106-4, or a combination thereof) may determine that sender vehicle 104 needs/intends to transmit the large data file to another vehicle. Accordingly, while sender vehicle 104 traverses region 150(a) on approach to traffic signal waiting zone 150(b), V2X pairing selection system 110 can select, from prospective receiver vehicles 102, 106-1, 106-2, 106-3, and 106-4, a vehicle to receive the large data file from sender vehicle 104 when sender vehicle 104 and the (receiver) vehicle are within traffic signal waiting zone 150(b). For example (based on factors discussed in more detail below), V2X pairing selection system 110 may select prospective receiver vehicle 102 to receive the large data file from sender vehicle 104 when sender vehicle 104 and prospective receiver vehicle 102 are within traffic signal waiting zone 150(b). Accordingly, before sender vehicle 104 and prospective receiver vehicle 102 reach traffic signal waiting zone 150(b), V2X pairing selection system 110 can assign sender vehicle 104 and prospective receiver vehicle 102 as a sender-receiver pair for transmitting the large data file when sender vehicle 104 and prospective receiver vehicle 102 are within traffic signal waiting zone 150(b). In certain implementations, V2X pairing selection system 110 can cause, before sender vehicle 104 and prospective receiver vehicle 102 reach traffic signal waiting zone 150(b), sender vehicle 104 and prospective receiver vehicle 102 to establish a V2X connection for transmitting the large data file. Accordingly, sender vehicle 104 can start transmitting the large data file immediately upon reaching (or stopping within) traffic signal waiting zone 150(b).

As described above, V2X pairing selection system 110 can use various techniques to select sender vehicle 104 and prospective receiver vehicle 102 as a sender-receiver pair for transmitting the large data file when sender vehicle 104 and prospective receiver vehicle 102 are within traffic signal waiting zone 150(b).

For example, in certain implementations V2X pairing selection system 110 can first predict that one or more vehicles traversing region 150(a), including prospective receiver vehicle 102, will travel in a common direction with sender vehicle 104 after leaving traffic signal waiting zone 150(b) (e.g., straight through an intersection, make a right-hand turn onto a new road segment, etc.). This first prediction can be important in situations where transfer for the large data file may need to continue after leaving traffic signal waiting zone 150(b) (e.g., at the next traffic signal waiting zone of road segment 150). V2X pairing selection system 110 can next predict that among the one or more vehicles predicted to travel in the common direction with sender vehicle 104 after leaving traffic signal waiting zone 150(b), prospective receiver vehicle 102 will be a shortest distance from sender vehicle 104 when sender vehicle 104 is stopped within traffic signal waiting zone 150(b). This second prediction can be important for improved V2C communication performance—which generally increases with decreasing proximity between a sender-receiver pair. Accordingly, based on the first and second predictions, V2X pairing selection system 110 can select prospective receiver vehicle 102 to receive the large data file from sender vehicle 104 when sender vehicle 104 and prospective receiver vehicle 102 are within traffic signal waiting zone 150(b).

As alluded to above, V2C pairing selection system 110 may rely on V2X communications between vehicles to make the predictions of the previous paragraph. By their nature, such V2X communications may be less sensitive to V2X network performance than transferring the large data file.

For example, V2X pairing selection system 110 can leverage intent messages or navigation data shared amongst vehicles traversing region 150(a) to predict that the one or more vehicles traversing region 150(a), including prospective receiver vehicle 102, will travel in the common direction with sender vehicle 104 after leaving traffic signal waiting zone 150(b). V2X pairing selection system 110 can also utilize contemporaneous orientations, headings, and lane positions of the one or more vehicles to predict they will travel in the common direction with sender vehicle 104 after leaving traffic signal waiting zone 150(b).

As another example, V2X pairing selection system 110 can leverage round-trip time (RTT) for packets exchanged between vehicles to estimate contemporaneous distances between the vehicles as they traverse region 150(a). V2X pairing selection system 110 can use such contemporaneous distances to predict future distances between the vehicles when they reach traffic signal waiting zone 150(b).

V2X pairing selection system 110 can also predict future distances between the vehicles based on one or more of: (1) contemporaneous lane positions of the vehicles as they traverse region 150(a); and (2) predicted lane changes by one or more of the vehicles before reaching traffic signal waiting zone 150(b). For example, V2X pairing selection system 110 can predict lane changes made by sender vehicle 104, prospective receiver 102, prospective receiver vehicle 106-1, and prospective receiver vehicle 106-2, based on at least one of: (1) intent messages shared these vehicles; (2) navigation data of these vehicles; and (3) contemporaneous orientations and headings of these vehicles. As described above, V2X pairing selection system 110 can use such predicted lane changes to more intelligently predict future distances between the vehicles when they reach traffic signal waiting zone 150(b)—along with predicting potential/future obstructions between a prospective sender-receiver pair.

By performing the above-described analysis and V2X communications to make intelligent sender-receiver pair selections before reaching traffic signal waiting zone 150(b), V2X pairing selection system 110 can reduce the quantity of packets exchanged and V2X communication link setup times within the traffic waiting zone within traffic signal waiting zone 150(b). Accordingly, V2X pairing selection system 110 can reduce load (e.g., as measured by a number of packets exchanged and V2X communication link setup times) on wireless communication channels at traffic signal waiting zone 150(b) and improve efficiency of V2X communication therein.

As described above, in various implementations, V2X pairing selection system 110 can make the above-described sender-receiver pair selection (i.e., between sender vehicle 104 and prospective receiver vehicle 104) in response to: (1) detecting sender vehicle 104 is within a threshold distance from traffic signal waiting zone 150(b) (e.g., within 200 feet); and (2) predicting that sender vehicle 104 will stop within traffic signal waiting zone 150(b) for over a threshold time interval (e.g., a time interval sufficient to transmit the large data file). In this way, V2X pairing selection system 110 can reduce the likelihood of making an improper sender-receiver pair selection, or making a sender-receiver pair selection that does not result in transmission of the large data file. In some implementations, V2X pairing selection system 110 can determine the threshold time interval based on a size of the large data file to be transferred. Relatedly, where traffic signal 170 is a traffic light, predicting that sender vehicle 104 will stop within traffic signal waiting zone 150(b) for over the threshold time interval can be based on known timing of the traffic light.

As alluded to above, in certain implementations sender vehicle 104 and prospective receiver vehicles 102, 106-1, 106-2, 106-3 and 106-4 may form a VMC. A VMC may refer to a group of vehicles that share resources (e.g., sensor resources, processing resources, memory resources, communication resources, etc.) to complete a task.

As an illustrative example, prospective receiver vehicle 102 (referred to hereafter as leader 102) may be a leader of VMC 100. Leader 102 may be a vehicle (or in some cases a piece of roadside infrastructure or more generally a remote server) that manages operation of VMC 100. For example, leader 102 may receive a request for a task to be completed, assign sub-tasks to particular VMC members, receive the output/results of completed sub-tasks, aggregate/combine the output/results of the completed sub-tasks into an output/results of the overall task, and promulgate the output/results of the overall task to VMC members. In the context of the present application, leader 102 may, in some examples, select and assign sender-receiver pairs for transmitting data at traffic waiting zones. For example, based on communications between vehicles of VMC 100, leader 102 may select itself as a receiver of the large data file within traffic signal waiting zone 150(b). Accordingly, leader 102 can assign itself and sender vehicle 104 as a sender-receiver pair, and in some cases, establish a V2X connection with sender vehicle 104 before reaching traffic signal waiting zone 150(b).

The following paragraphs describe operation of VMC 100 (as an example of a VMC) more generally.

As described above, through VMC 100, leader 102, sender vehicle 104, and prospective receiver vehicles 106-1, 106-2, 106-3, and 106-4 can share resources. Examples of shared resources may include sensor resources, processing resources, memory resources, communication resources, network bandwidth resources, etc. Examples of VMC sub-tasks that may be completed by a vehicle in VMC 100 may include executing software, executing calculations, sending/receiving messages or data, finding digital data stored by any member of VMC 100, instructing different members of VMC 100 to help with calculations, etc. Examples of information shared within VMC 100 may include image frames or video feeds from image sensors, image processing results, object detection results from proximity sensors, GPS coordinates, computation results from processing data from sensor sets, etc.

While particular reference is made to particular sub-tasks, various other sub-tasks may be completed by the members of VMC 100. When the various members complete these sub-tasks, leader 102 can provide a resultant/combined output of the sub-tasks to the members of VMC 100. That is, leader 102 (or in some cases a remote server) can aggregate data/output from the members to provide collaborative results relevant to a requested (overall) VMC task. Examples of tasks completed by VMC 100 may include dynamic map generation, cooperative path planning, distributed data storage, etc.

As described above, the members of VMC 100 may communicate using a V2X network that enables vehicles to wirelessly communicate via one or more communication protocols. Examples of V2X networks may include Dedicated Short Range Communication (DSRC) networks used to send Basic Safety Messages (BSMs) and Personal Safety Messages (PSMs), among other types of DSRC communications. Other examples of V2X networks can include Bluetooth® networks; Long-Term Evolution (LTE) networks; millimeter wave (mmWave) networks; 3G networks; 4G networks; 5G networks; Voice over LTE (VoLTE) networks; etc.

As described above, V2X networks can include V2V networks, V2I networks, V2N networks, or any combination thereof.

While particular reference is made to particular communication modalities of VMC 100, the communication network may include other connected paths across which multiple vehicles may communicate including other cellular or mobile communications networks. In other implementations, VMC 100 may comprise a network other than a V2X network. For example, certain V2X networks may not allow members to access and use the unused computing resources of the other endpoints of such networks. By comparison, VMC 100 may allow all members to access and use designated unused computing resources of the other members of VMC 100.

In various implementations, a respective member of VMC 100 can join VMC 100 via a handshake process with a coordinator of VMC 100 (e.g., leader 102 or a remote server). In certain implementations, the memory of a respective member can store member data. The member data may comprise digital data that describes one or more of the following: the identity of each of the members; what digital data, or bits of data, are stored by each member; what computing services are available from each member; what computing resources are available from each member and what quantity of these resources are available; and how to communicate with each member. In some implementations, the member data may also describe logical associations between vehicles.

VMC 100 may comprise various types of VMCs.

For example, VMC 100 may comprise a stationary VMC that is tied to a fixed geographical region (e.g., traffic signal waiting zone 150(b)). A vehicle can join a stationary VMC and contribute its resources upon entering the fixed geographical region as determined by a GPS sensor of the vehicle. The vehicle may leave the stationary VMC upon exiting from the fixed geographical region. When exiting from the fixed geographical region, the vehicle may hand over ongoing sub-tasks and data of the stationary VMC to other members.

As another example, VMC 100 may comprise a mobile VMC. A mobile VMC may be formed around a particular vehicle (e.g., leader 102) traversing segment 150. Vehicles within a threshold distance of the particular vehicle can join the mobile VMC via a handshake operation. As the particular vehicle moves, the geographic location of the mobile VMC may change with the movement of the particular vehicle and other members of the mobile VMC. A vehicle can join the mobile VMC when the vehicle is in an area covered by the mobile VMC. The vehicle can leave the mobile VMC when the vehicle exits the area covered by the mobile VMC. Where VMC 100 is a mobile VMC, leader 102 may advertise VMC 100, and vehicles within a threshold distance of leader 102 may join/participate in VMC 100.

As another example, VMC 100 may comprise one of consecutive interdependent VMCs formed along road segment 150. For example, it may be the case that one mobile VMC is not sufficient to carry out a VMC task, such as defining a model of the behavior of vehicles on a particular stretch of the roadway. Accordingly, as leader 102 travels along the roadway, it may pass through different VMCs, and the different VMCs can perform different sub-tasks such that the output of the different VMCs may be used to generate a larger output that spans multiple regions associated with the individual VMCs.

In yet another example, VMC 100 may comprise a remote VMC where an ego vehicle can be connected to other vehicles that are remote from the ego vehicle. In this example, the ego vehicle may be a remote leader and remotely control the collaboration of members. For example, an ego vehicle in one city may want to know the parking availability in a city spaced apart from the city where the ego vehicle is located. In this example, the ego vehicle could form a remote VMC with vehicles in the target city. The vehicles in the target city, using exterior sensors, could indicate parking availability to the ego vehicle.

While particular types of VMCs are described herein, different types of VMCs 100 may be implemented in accordance with the principles described herein.

As described above, VMC 100 may include leader 102 that initiates formation of VMC 100 and otherwise manages VMC 100. In the context of the present application, leader 104 select/assign sender-receiver pairs, cause selected sender-receiver pairs to establish a V2X connection for transmitting data prior to reaching a traffic waiting zone, etc.

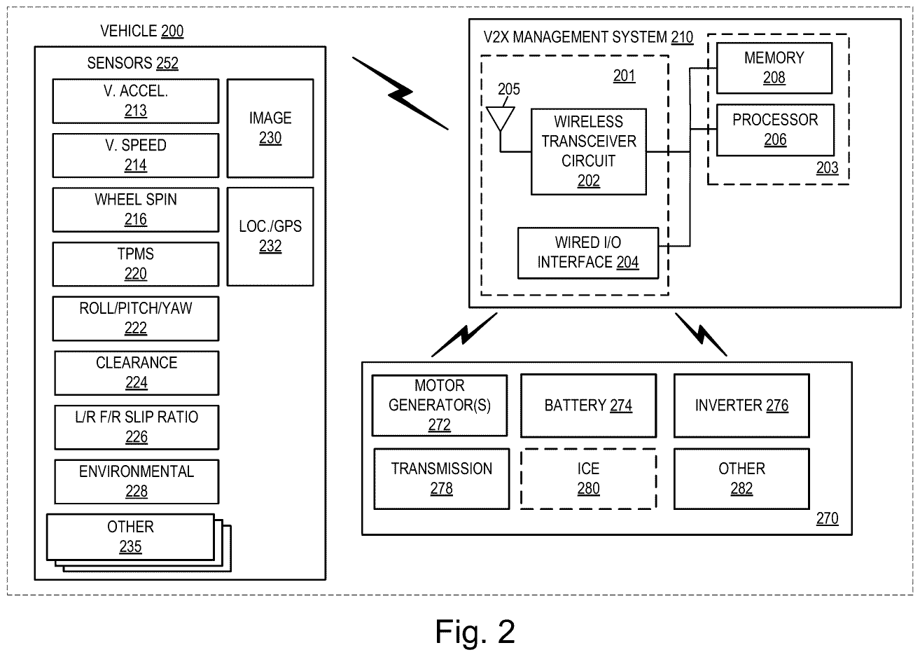

FIG. 2 illustrates an example vehicle 200, in accordance with various embodiments of the presently disclosed technology. Vehicle 200 may be an example of any of the vehicles depicted and described in conjunction with FIGS. 1A-1B.

As depicted, vehicle 200 comprises a V2X management system 210, sensors 252, and additional vehicle systems 270. Sensors 252 and additional vehicle systems 270 can communicate with V2X management system 210 via a wired or wireless communication interface. Although sensors 252 and additional vehicle systems 270 are depicted as communicating with V2X management system 210, they can also communicate with each other. V2X management system 210 can be implemented as an electronic control unit (ECU) or as part of an ECU. In other embodiments, V2X management system 210 can be implemented independently of an ECU.

In the specific example of FIG. 2, V2X management system 210 includes a communication circuit 201 and a decision circuit 203 (including a processor 206 and a memory 208). Components of V2X management system 210 are illustrated as communicating with each other via a data bus, although other interfaces can be included.

Processor 206 can include one or more general processing units (GPUs), central processing units (CPUs), microprocessors, or any other suitable processing system. Processor 206 may include a single core processor or multicore processors. Memory 208 can be made up of one or more modules of one or more different types of memory (e.g., flash, RAM, etc.) that may be used to store data related to VMC tasks, instructions and variables for processor 206, as well as any other suitable information.

Although the example of FIG. 2 is illustrated using processor and memory circuitry, in various embodiments decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up V2X management system 210.

Communication circuit 201 can utilize a wireless transceiver circuit 202 with an associated antenna 205 for wireless communication. Communication circuit 201 can also utilize a wired I/O interface 204 with an associated hardwired data port (not illustrated). As this example illustrates, communications with V2X management system 210 can include either or both wired and wireless communications. Wireless transceiver circuit 202 can include a transmitter and a receiver to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment and to receive radio signals as well. These radio signals can include information of almost any sort that is sent or received by V2X management system 210 to/from other entities such as sensors 252, additional vehicle systems 270, other vehicles, connected roadside infrastructure, cloud computing entities, remote servers, etc.

Wired I/O interface 204 can include a transmitter and a receiver (not shown) for hardwired communications with other devices. For example, wired I/O interface 204 can provide a hardwired interface to other components, including sensors 252 and additional vehicle systems 270. Wired I/O interface 204 can communicate with other devices using Ethernet or any of a number of other wired communication protocols whether standardized, proprietary, open, point-to-point, networked or otherwise.

In certain implementations, decision circuit 203 and communication circuit 201 may be used for computation, memory, or communication tasks beyond V2X management. In other implementations, vehicle 200 may comprise additional processing, memory, or communication resources (not depicted) devoted to these other tasks.

Sensors 252 can include, for example, vehicle acceleration sensors 213, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, environmental sensors 1228 (e.g., to detect salinity or other environmental conditions), image sensor(s) 230, and location sensor(s) 232. Other sensors 235 can also be included as may be appropriate for a given implementation of vehicle 200. For example, other sensors 235 may include proximity sensors such as radar sensors, LiDAR sensors, and sonar sensors, etc.

In some embodiments, image sensor(s) 230 may comprise one or more cameras (e.g., monocular cameras, stereoscopic cameras, RGB cameras, infrared cameras, etc.) configured to obtain image data of an environment surrounding vehicle 200. Such image data (and sometimes in combination with proximity data obtained from proximity sensors), can be used to detect relative positions and distances of other vehicles, distance between vehicle 200 and a traffic waiting zone, etc.

In certain embodiments, location sensor(s) 232 may comprise a global navigation satellite sensor, a global position sensor, or other types of vehicle positioning sensors. Location sensor(s) 232 may be configured to generate location data for vehicle 200 and/or location data for landmarks in the environment surrounding vehicle 200 (e.g., traffic waiting zones). The location data may comprise precise coordinates (e.g., latitude, longitude, and altitude) of vehicle 200's position or the position(s) of landmark(s) on the Earth's surface.

In some embodiments, one or more of sensors 252 may include their own processing capability to compute the results for additional information that can be provided to V2X management system 210. In other embodiments, one or more of sensors 252 may be data-gathering-only sensors that only provide raw data to V2X management system 210. In further embodiments, one or more hybrid sensors may be included that provide a combination of raw data and processed data to V2X management system 210. Sensors 252 may provide analog outputs, digital outputs, or a combination of both.

Additional vehicle systems 270 can include any of a number of different vehicle components or subsystems used to control or monitor various aspects of vehicle 200 and its performance. For example, additional vehicle systems 270 may include any one or combination of a motor generator system 272, a battery system 274, an inverter 276, and a transmission 278. In implementations where vehicle 200 is a hybrid vehicle, additional vehicle systems 270 may further comprise an internal combustion engine (ICE) 280. Additional vehicle systems 270 may also comprise other vehicle systems 282.

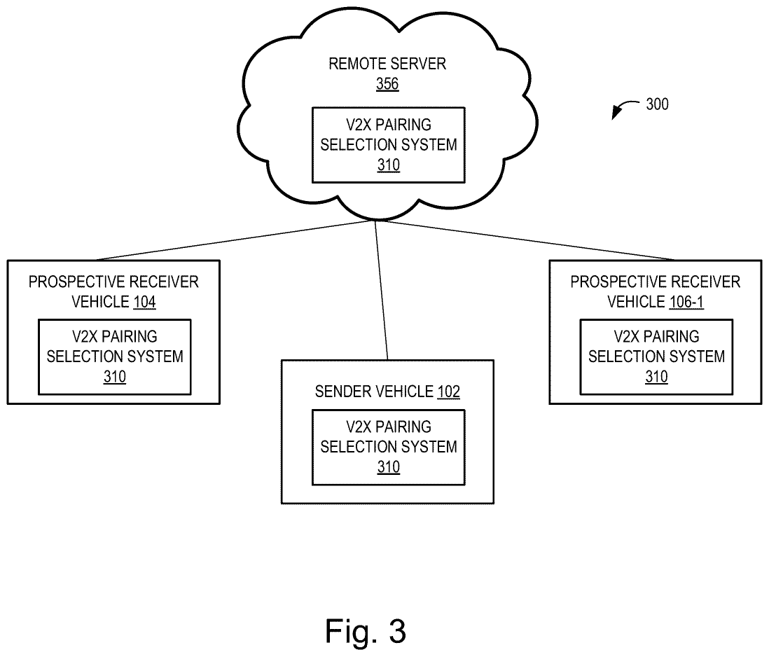

FIG. 3 depicts an example V2X pairing selection system 310, in accordance with various embodiments of the presently disclosed technology. Here, V2X pairing selection system 310 be an example of V2X pairing selection system 110 from FIGS. 1A-1B.

As depicted in FIG. 3, in some embodiments V2X pairing selection system 310 may be implemented across a remote server 356 and one or more vehicle traversing a road segment, such as sender vehicle 102, prospective receiver vehicle 104, and prospective receiver vehicle 106-1 from FIGS. 1A-1B. Such embodiments may be facilitated by a remote environment 300. In some embodiments, remove environment 300 may comprise a cloud-based environment. In other embodiments, remote environment 300 may comprise an edge-based environment. Such an edge-based environment can utilize various types of edge infrastructure, such as roadside/traffic infrastructure, cellular network infrastructure, etc.

In some embodiments, the vehicles across which V2X pairing selection system 310 is implemented may comprise a VMC.

Accordingly, as shown, V2X pairing selection system 310 may include separate instances within one or more entities of remote environment 300, such as remote server 356, sender vehicle 102, prospective receiver vehicle 104, and prospective receiver vehicle 106-1. In a further aspect, the entities that implement V2X pairing selection system 310 within remote environment 300 may vary beyond transportation-related devices and encompass roadside infrastructure elements. Thus, the set of entities that function in coordination with remote environment 300 may be varied.

In some embodiments, remote environment 300 itself, may comprise a dynamic environment that comprises cloud members that migrate into and out of a geographic area.

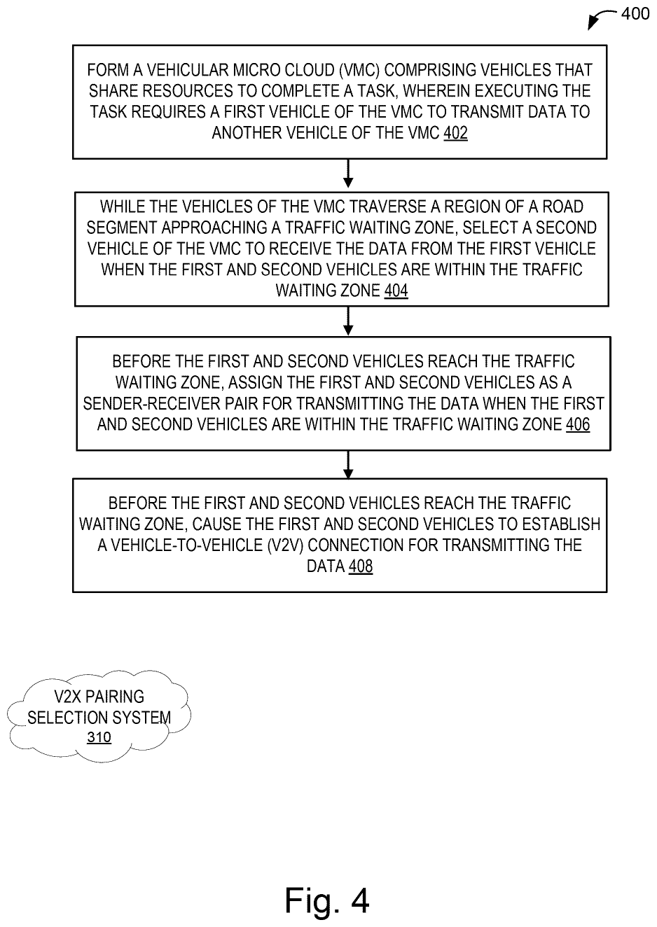

FIG. 4 illustrates an example process 400 that may be performed by V2X pairing selection management system 310 from FIG. 3, in accordance with various embodiments of the presently disclosed technology.

As depicted, V2X pairing selection management system 310 can perform operation 402 to form a vehicular micro cloud (VMC) comprising vehicles that share resources to complete a task, wherein executing the task requires a first vehicle of the VMC to transmit data to another vehicle of the VMC.

While the vehicles of the VMC traverse a region of a road segment approaching a traffic waiting zone (e.g., a traffic signal waiting zone), V2X pairing selection management system 310 can perform operation 402 to select a second vehicle of the VMC to receive the data from the first vehicle when the first and second vehicles are within the traffic waiting zone.

As described above, the traffic waiting zone may comprise a second region of the road segment where nominal vehicle speed is stopped or is less than 5 MPH. In certain situations, the traffic waiting zone may comprise a traffic signal waiting zone. The traffic signal waiting zone may be bounded at one end by a traffic signal, and extend away from the traffic signal towards the region of the road segment by a determined distance.

In some implementations, selecting the second vehicle of the VMC may comprise: (1) predicting that one or more vehicles of the VMC, including the second vehicle, will travel in a common direction with the first vehicle after leaving traffic waiting zone; (2) predicting that among the one or more vehicles of the VMC predicted to travel in the common direction with the first vehicle after leaving the traffic waiting zone, the second vehicle will be a shortest distance from the first vehicle when the first vehicle is stopped within the traffic waiting zone; and (3) selecting the second vehicle based on the predictions.

Here, predicting that the one or more vehicles of the VMC, including the second vehicle, will travel in the common direction with the first vehicle after leaving the traffic waiting zone may be based on at least one of: (a) intent messages shared by the one or more vehicles predicted to travel in the common direction with the first vehicle after leaving the traffic waiting zone; (b) navigation data of the one or more vehicles predicting to travel in the common direction with the first vehicle after leaving the traffic waiting zone; (c) contemporaneous orientations and headings of the one more vehicles predicted to travel in the common direction with the first vehicle after leaving the traffic waiting zone; and (d) contemporaneous lane positions of the one more vehicles predicted to travel in the common direction with the first vehicle after leaving the traffic waiting zone.

Relatedly, predicting that among the one or more vehicles of the VMC predicted to travel in the common direction with the first vehicle after leaving the traffic waiting zone, the second vehicle will be the shortest distance from the first vehicle when the first vehicle is stopped within the traffic waiting zone can be based on at least one of:
(a) contemporaneous distances between the vehicles of the VMC when traversing the road segment; (b) contemporaneous relative positions of the vehicles of the VMC within lanes of the road segment when traversing the road segment; and (c) predicted lane changes by one or more vehicles of the VMC before reaching the traffic waiting zone.

In some implementations, V2X pairing selection management system 310 can determine the contemporaneous distances between the vehicles of the VMC based on round-trip time (RTT) for packets exchanged between the vehicles of the VMC when traversing the road segment.

In certain implementations, the predicted lane changes may be based on at least one of: (i) intent messages shared by the one or more vehicles predicted to change lanes; (ii) navigation data of the one or more vehicles predicted to change lanes; and (iii) contemporaneous orientations and headings of the one more vehicles predicted to change lanes.

In various implementations, prior to selecting the second vehicle to receive the data from the first vehicle, V2X pairing selection management system 310 can: (1) determine at least one vehicle of the VMC is within a second threshold distance of the traffic waiting zone; and (2) predict that the first vehicle will stop within the traffic waiting zone for over a threshold time interval. Accordingly, selecting the second vehicle of the VMC may be responsive to the determination that at least one vehicle of the VMC is within the second threshold distance of the traffic waiting zone and the prediction that the first vehicle will stop within the traffic waiting zone for over the threshold time interval.

In certain implementations, V2X pairing selection management system 310 can determine the threshold time interval based on a size of the data to be transferred within the traffic waiting zone. Relatedly, in examples where the traffic waiting zone is a traffic signal waiting zone associated with a traffic light, V2X pairing selection management system 310 can predict that the first vehicle will stop within the traffic signal waiting zone for over the threshold time interval based on known timing of the traffic light.

Before the first and second vehicles reach the traffic waiting zone (and as depicted), V2X pairing selection management system 310 can perform operation 406 to assign the first and second vehicles as a sender-receiver pair for transmitting the data when the first and second vehicles are within the traffic waiting zone.

Relatedly (and also before the first and second vehicles reach the traffic waiting zone), V2X pairing selection management system 310 can perform operation 408 to cause the first and second vehicles to establish a vehicle-to-everything (V2X) connection for transmitting the data.

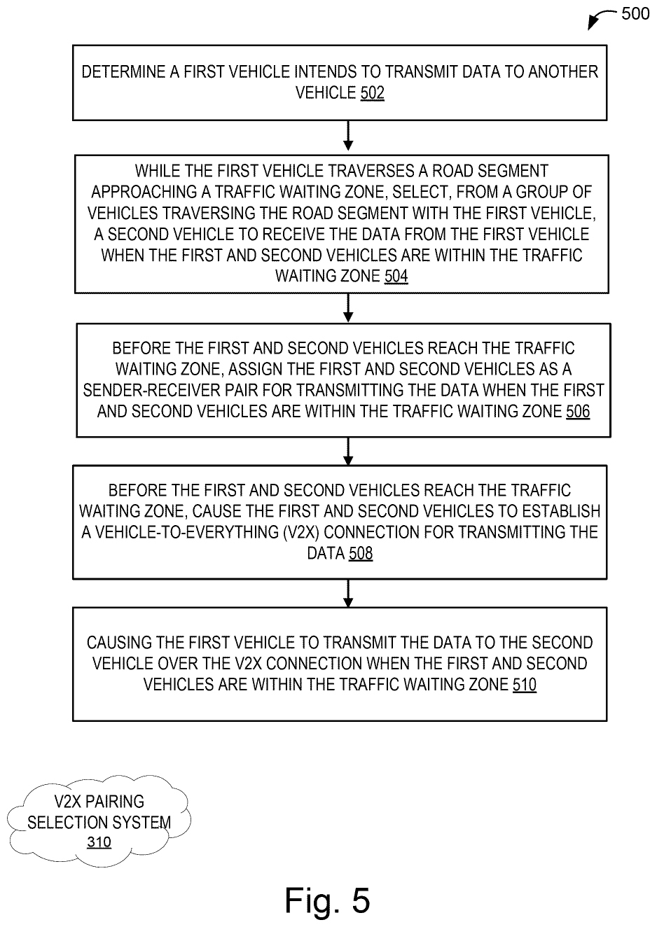

FIG. 5 illustrates an example process 500 that may be performed by V2X pairing selection management system 310 from FIG. 3, in accordance with various embodiments of the presently disclosed technology.

As depicted, V2X pairing selection management system 310 can perform operation 502 to determine a first vehicle intends to transmit data to another vehicle.

While the first vehicle traverses a road segment approaching a traffic waiting zone, V2X pairing selection management system 310 can perform operation 504 to select, from a group of vehicles traversing the road segment with the first vehicle, a second vehicle to receive the data from the first vehicle when the first and second vehicles are within the traffic waiting zone.

Before the first and second vehicles reach the traffic waiting zone, V2X pairing selection management system 310 can perform operation 506 to assign the first and second vehicles as a sender-receiver pair for transmitting the data when the first and second vehicles are within the traffic waiting zone.

Also before the first and second vehicles reach the traffic waiting zone, V2X pairing selection management system 310 can perform operation 508 to cause the first and second vehicles to establish a V2X connection for transmitting the data.

Accordingly, V2X pairing selection management system 310 can perform operation 510 to cause the first vehicle to transmit the data to the second vehicle over the V2X connection when the first and second vehicles are within the traffic waiting zone.

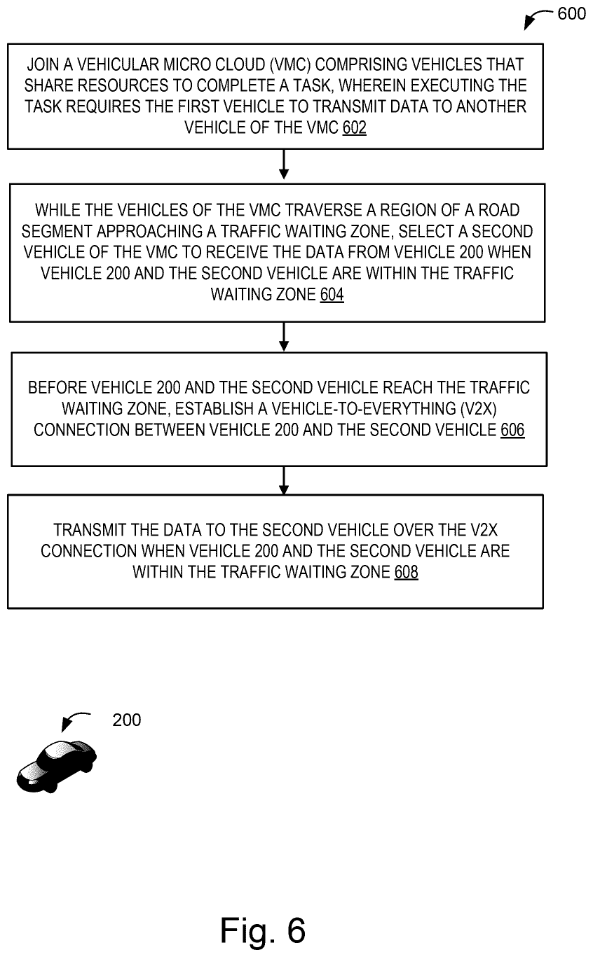

FIG. 6 illustrates an example process 600 that may be performed by vehicle 200 from FIG. 2 to make an anticipatory V2X pairing selection, in accordance with various embodiments of the presently disclosed technology.

As depicted, vehicle 200 can perform operation 602 to join a vehicular micro cloud (VMC) comprising vehicles that share resources to complete a task, wherein executing the task requires vehicle 200 to transmit data to another vehicle of the VMC.

In certain implementations, joining the VMC may comprise forming the VMC and becoming leader of the VMC.

While the vehicles of the VMC traverse a region of a road segment approaching a traffic waiting zone, vehicle 200 can perform operation 604 to select a second vehicle of the VMC to receive the data from vehicle 200 when vehicle 200 and the second vehicle are within the traffic waiting zone.

Before vehicle 200 and the second vehicle reach the traffic waiting zone, vehicle 200 can perform operation 606 to establish a V2X connection between vehicle 200 and the second vehicle.

Accordingly, vehicle 200 can perform operation 608 to transmit the data to the second vehicle over the V2X connection when vehicle 200 and the second vehicle are within the traffic waiting zone.

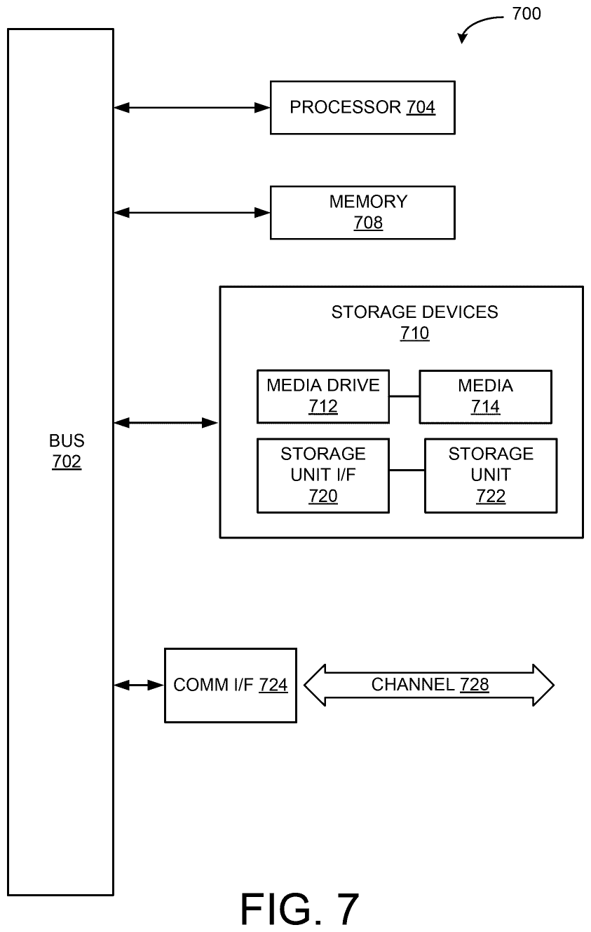

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up a user device, a user system, and a non-decrypting cloud service. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is target or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
one or more processors; and
memory storing machine-readable instructions that, when executed by the one or more processors, cause the system to:
form a vehicular micro cloud (VMC) comprising vehicles that share resources to complete a task, wherein executing the task requires a first vehicle of the VMC to transmit data to another vehicle of the VMC;
while the vehicles of the VMC traverse a region of a road segment approaching a traffic waiting zone, select a second vehicle of the VMC to receive the data from the first vehicle when the first and second vehicles are within the traffic waiting zone; and
before the first and second vehicles reach the traffic waiting zone, assign the first and second vehicles as a sender-receiver pair for transmitting the data when the first and second vehicles are within the traffic waiting zone.

2. The system of claim 1, wherein the memory stores further machine-readable instructions that, when executed by the one or more processors, cause the system to:
before the first and second vehicles reach the traffic waiting zone, cause the first and second vehicles to establish a vehicle-to-everything (V2X) connection for transmitting the data.

3. The system of claim 1, wherein:
the traffic waiting zone comprises a second region of the road segment, bounded at one end by a traffic signal, and extending away from the traffic signal towards the region of the road segment by a determined distance.

4. The system of claim 3, wherein the memory stores further machine-readable instructions that, when executed by the one or more processors, cause the system to:
determine at least one vehicle of the VMC is within a second threshold distance of the traffic waiting zone;
wherein selecting the second vehicle of the VMC is responsive to the determination that at least one vehicle of the VMC is within the second threshold distance of the traffic waiting zone.

5. The system of claim 3, wherein the memory stores further machine-readable instructions that, when executed by the one or more processors, cause the system to:
determine at least one vehicle of the VMC is within a second threshold distance of the traffic waiting zone; and
predict that the first vehicle will stop within the traffic waiting zone for over a threshold time interval;
wherein selecting the second vehicle of the VMC is responsive to the determination that at least one vehicle of the VMC is within the second threshold distance of the traffic waiting zone and the prediction that the first vehicle will stop within the traffic waiting zone for over the threshold time interval.

6. The system of claim 5, wherein the memory stores further machine-readable instructions that, when executed by the one or more processors, cause the system to:
determine the threshold time interval based on a size of the data to be transferred within the traffic waiting zone.

7. The system of claim 5, wherein:
the traffic signal comprises a traffic light; and
predicting that the first vehicle will stop within the traffic waiting zone for over the threshold time interval is based on known timing of the traffic light.

8. The system of claim 1, wherein selecting the second vehicle of the VMC comprises:
predicting that among the vehicles of the VMC, the second vehicle will be a shortest distance from the first vehicle when the first vehicle is stopped within the traffic waiting zone; and
selecting the second vehicle is based on the prediction that among the vehicles of the VMC, the second vehicle will be a shortest distance from the first vehicle when the first vehicle is stopped within the traffic waiting zone.

9. The system of claim 8, wherein predicting that among the vehicles of the VMC, the second vehicle will be the shortest distance from the first vehicle when the first vehicle is stopped within the traffic waiting zone is based on at least one of:
contemporaneous distances between the vehicles of the VMC when traversing the road segment;
contemporaneous relative positions of the vehicles of the VMC within lanes of the road segment when traversing the road segment; and
predicted lane changes by one or more vehicles of the VMC before reaching the traffic waiting zone.

10. The system of claim 9, wherein the memory stores further machine-readable instructions that, when executed by the one or more processors, cause the system to:
determine the contemporaneous distances between the vehicles of the VMC based on round-trip time (RTT) for packets exchanged between the vehicles of the VMC when traversing the road segment.

11. The system of claim 9, wherein the predicted lane changes are based on at least one of:
intent messages shared by the one or more vehicles predicted to change lanes;
navigation data of the one or more vehicles predicted to change lanes; and
contemporaneous orientations and headings of the one more vehicles predicted to change lanes.

12. The system of claim 1, wherein selecting the second vehicle of the VMC comprises:
predicting that one or more vehicles of the VMC, including the second vehicle, will travel in a common direction with the first vehicle after leaving the traffic waiting zone;
predicting that among the one or more vehicles of the VMC predicted to travel in the common direction with the first vehicle after leaving the traffic waiting zone, the second vehicle will be a shortest distance from the first vehicle when the first vehicle is stopped within the traffic waiting zone; and
selecting the second vehicle based on the predictions.

13. The system of claim 12, wherein predicting that the one or more vehicles of the VMC, including the second vehicle, will travel in the common direction with the first vehicle after leaving the traffic waiting zone is based on at least one of:
intent messages shared by the one or more vehicles predicted to travel in the common direction with the first vehicle after leaving the traffic waiting zone;
navigation data of the one or more vehicles predicted to travel in the common direction with the first vehicle after leaving the traffic waiting zone;
contemporaneous orientations and headings of the one more vehicles predicted to travel in the common direction with the first vehicle after leaving the traffic waiting zone; and
contemporaneous lane positions of the one more vehicles predicted to travel in the common direction with the first vehicle after leaving the traffic waiting zone.

14. The system of claim 1, wherein the system is implemented in at least one of the vehicles of the VMC.

15. The system of claim 1, wherein the system is implemented as a remote computing system.

16. A method comprising:
determining a first vehicle intends to transmit data to another vehicle;
while the first vehicle traverses a road segment approaching a traffic waiting zone, selecting, from a group of vehicles traversing the road segment with the first vehicle, a second vehicle to receive the data from the first vehicle when the first and second vehicles are within the traffic waiting zone; and
before the first and second vehicles reach the traffic waiting zone, assigning the first and second vehicles as a sender-receiver pair for transmitting the data when the first and second vehicles are within the traffic waiting zone.

17. The method of claim 16, further comprising:
before the first and second vehicles reach the traffic waiting zone, causing the first and second vehicles to establish a vehicle-to-everything (V2X) connection for transmitting the data; and
causing the first vehicle to transmit the data to the second vehicle over the V2X connection when the first and second vehicles are within the traffic waiting zone.

18. A first vehicle comprising:
one or more processors; and
memory storing machine-readable instructions that, when executed by the one or more processors, cause the first vehicle to:
join a vehicular micro cloud (VMC) comprising vehicles that share resources to complete a task, wherein executing the task requires the first vehicle to transmit data to another vehicle of the VMC;
while the vehicles of the VMC traverse a region of a road segment approaching a traffic waiting zone, select a second vehicle of the VMC to receive the data from the first vehicle when the first and second vehicles are within the traffic waiting zone;
before the first and second vehicles reach the traffic waiting zone, establish a vehicle-to-everything (V2X) connection between the first and second vehicles; and
transmit the data to the second vehicle over the V2X connection when the first and second vehicles are within the traffic waiting zone.

19. The first vehicle of claim 18, wherein joining the VMC comprises forming the VMC and becoming leader of the VMC.

20. The first vehicle of claim 18, wherein:
the traffic waiting zone comprises a second region of the road segment, bounded at one end by a traffic signal, and extending away from the traffic signal towards the region of the road segment by a determined distance.
